(19) United States
(12) Patent Application Publication
(10) Pub. No.: US 2004/0231139 A1
(43) Pub. Date: Nov. 25, 2004

(54) Method and system for adjustment of components in a head stack assembly

(76) Inventor: Ryan A. Jurgenson, Hutchinson, MN (US)

Correspondence Address: Michaele A. Hakamaki, Kagan Binder, PLLC, Maple Island Building, Suite 200, 221 Main Street North, Stillwater, MN, 55082, US

(21) Appl. No.: 10/442,339

(22) Filed: May 20, 2003

(51) Int. Cl. G11B 5/127; B23P 19/00; H04R 31/00

(52) U.S. Cl. 29/603.03; 29/603.04; 29/603.09; 29/737

(57) ABSTRACT

A method of measuring and adjusting at least one of a plurality of head suspension assemblies in a head stack assembly is provided, each head suspension assembly having a pivot axis, comprising the steps of stacking a plurality of head suspension assemblies with the pivot axis of each head suspension assembly aligned with the pivot axis of at least one adjacent head suspension assembly, wherein at least one of the head suspension assemblies is rotated about its pivot axis relative to at least one adjacent head suspension assembly so that all of the plurality of head suspension assemblies are not in vertical alignment, measuring at least one parameter of at least one head suspension assembly, then rotating each of the plurality of head suspension assemblies that are not in vertical alignment with the other head suspension assemblies about its pivot axis until the plurality of head suspension assemblies are vertically aligned.

### TECHNICAL FIELD

The present invention relates to head stack assemblies for suspending and positioning read/write heads relative to magnetic media of the type generally used in dynamic storage devices such as magnetic disk drives. In particular, the present invention is directed to methods and apparatuses for measuring and adjusting head suspensions as they are mounted in a stacked arrangement, such as in a head stack assembly.

### BACKGROUND OF THE INVENTION

Components of many electronic, electromechanical, optical or other devices need to be assembled with precise alignment to assure optimal performance. In the case of certain magnetic recording disk drives, for example, at least one read/write head needs to be carefully positioned during disk usage with respect to the surface of a rotating disk to assure optimum performance and to avoid crashing into the disk and causing damage. In devices that include multiple read/write heads, each of the heads should be positioned relative to each other and to adjacent disk surfaces to allow for fast and accurate data storage and retrieval.

Magnetic recording hard disk drives that utilize a head assembly for reading and/or writing data on a rotating magnetic disk are well known in the art. In such systems, the head assembly is typically attached to an actuator arm by a head suspension assembly comprising a head suspension and an aerodynamically designed head slider or slider onto which a read/write head is provided so that the head assembly can be positioned very close to the disk surface. The position of the head over a spinning disk during usage is defined by balancing a lift force caused by an air bearing that spins with the disk acting upon the aerodynamically designed slider and an opposite bias force of the head suspension. As such, the slider and head are said to “fly” over the spinning disk at precisely determined heights.

Head suspensions generally include an elongated load beam with a gimbal flexure located at a distal end of the load beam and a base plate or other mounting means at a proximal end of the load beam. According to one version of a two-piece head suspension construction, the gimbal flexure comprises a platform or slider mounting tongue suspended by spring or gimbal arms. The slider is mounted to the tongue, thereby forming a head suspension assembly. The slider includes a read/write magnetic transducer provided on the slider and the slider is aerodynamically shaped to use the air bearing generated by a spinning disk to produce a lift force. During operation of such a disk drive, the gimbal arms permit the slider to pitch and roll about a load dimple or load point of the load beam, thereby allowing the slider to follow the plane of the disk surface.

In order for the slider to fly at a predetermined relationship to the plane of the disk surface, the slider is precisely mounted to the flexure or slider mounting tongue of a head suspension at a specific orientation. During manufacturing and assembling of the head suspension assembly, any lack of precision in forming or assembling the individual elements can contribute to a deviation in the desired relationship of the surfaces of the elements. A buildup of such deviations from tolerance limits and other parameters in the individual elements can cause a buildup of deviation from the desired relationship of the slider to the associated disk surface in the complete head suspension assembly.

A load beam mounting surface datum and a head slider surface datum are planar surfaces that are used as reference points or surfaces in establishing the relationship of the plane of the actuator mounting surface and the plane of the surface of the head slider surface relative to each other. For optimum operation of the disk drive as a whole, the plane of the load beam mounting surface datum and the plane of a head slider surface datum should be in a predetermined relationship to each other during assembly of the head slider to the slider mounting tongue. The upper and lower planar surfaces of the head slider are also manufactured according to specifications that usually require them to be essentially or nominally parallel to each other.

Conventional disk drives often utilize multiple disks that are provided in a stack that rotate about a common spindle, where each disk in the stack is positioned to be generally parallel to each of the other disks. To minimize the size of the disk drive, each disk in a stack is also typically spaced to be very close to each adjacent disk, with at least one read/write head positioned to move within this narrow space. This minimal space between adjacent disks thus complicates the process of precisely moving read/write heads to fly relatively close to the disk surfaces without allowing contact between the heads and the disk surfaces. To allow for accuracy in positioning the heads, the head suspension assemblies to which the heads are attached are often made of somewhat flexible materials that can be bent or otherwise adjusted to meet certain head positioning tolerances.

In operation, the multiple disks of a disk drive rotate at high speeds, while the read/write heads are positioned so that there is only a minimal air gap separation between the heads and the disk surfaces. Providing a consistent air gap separation (i.e., slider fly height) during operation of the disk drive is critical to assure accurate reading and storing of information on each disk. If the air gap is too large or if it varies during operation of the disk drive, critical information can be lost or misread by the heads. Conversely, if the air gap is eliminated such that one or more read/write heads can come into contact with an adjacent hard disk (i.e., a head crash), permanent loss of data can occur, along with damage to the heads and disks that may be difficult or impossible to repair. In order to maintain the necessary air gap separation, it is thus important to properly adjust and maintain various parameters of each suspension.

One factor that is important to adjusting the suspensions is to establish the proper gram load, which is the force at which a suspension urges a slider toward an adjacent disk. The gram load is selected to counteract the forces generated by the slider to maintain the proper fly height of the slider. A variety of techniques can be used to adjust the gram load within predetermined tolerances to achieve the proper fly height. The gram load adjustments typically occur during or at some time after the manufacturing of the suspension and typically include such techniques as, for example, mechanically bending the suspension in the region known as the spring region to increase or decrease the gram load. With this technique, precise computer controlled equipment can be used to calculate the amount of bend necessary to change the gram load of the suspension to be within a certain range, and then the suspension can be automatically or manually bent to achieve this configuration. Relationships between the amount of bend caused by each step of a stepper motor-driven bending mechanism, for example, and the resulting gram load changes can be empirically determined. A desired gram load correction may then be achieved by applying this empirical relationship to the associated measuring and adjusting equipment. Another type of gram load adjustment technique includes the application of heat to the spring region of the suspension to lower the mechanical stresses in that region, which can thereby controllably lower the gram load. Methods of this type may be referred to as “thermal adjust” or “light adjust” techniques and are based on the principle that load beams, which are often made of materials such as stainless steel, can be stress-relieved (i.e., internal material stress is reduced) by exposure to thermal energy. Because the functional relationship between the amount of force reduction and the amount of heat to which a material is exposed can also be empirically determined, the amount of heat needed to achieve a desired gram load can be precisely calculated and applied. These exemplary techniques and other gram load adjustment techniques are used alone or in combination with each other to provide the desired gram load. Separate fixtures or other devices are often provided to support the suspensions during gram load adjustments.

Another critical performance-related criterion of a suspension is specified in terms of its resonance characteristics. Resonance characteristics can be impacted by the shape and size of the bend provided in the spring region of a suspension, which is often referred to as the radius geometry or profile of the suspension. The radius geometry of a suspension must therefore be accurately controlled during the manufacturing of the suspension to optimize the resonance characteristics of the part. As discussed above, in order for a head slider to be accurately positioned with respect to a desired track on an adjacent magnetic disk, the head suspension should be capable of precisely translating or transferring the motion of the positioning actuator arm to the slider. An inherent property of moving mechanical systems, however, is their tendency to bend and twist in a number of different modes when subject to movements or vibrations at certain rates known as resonant frequencies. At any such resonant frequencies that may be experienced during disk drive usage, the movement of a distal tip of the head suspension assembly, or its gain, is preferably minimized by the construction of the head suspension assembly. Any bending or twisting of a head suspension can cause the position of the head slider to deviate from its intended position with respect to the desired track, particularly at such resonant frequencies. Since the disks and head suspension assemblies are driven at high rates of speed in high performance disk drives, the resonant frequencies of a head suspension should be as high as possible. Resonance characteristics are usually controlled by precision design and manufacture of the load beam, and precise adjustments of the load beam. Accordingly, any changes or deformation to a head suspension after it is constructed, such as may be done for adjusting the radius geometry or profile of a head suspension assembly component, may affect the resonant characteristics of the head suspension assembly.

Yet another important characteristic of a suspension that is related to its performance is known as its static attitude. The static attitude of a head slider refers to the positional orientation of the slider with respect to the surface of the disk over which it is flying, where it is typically desirable that the head slider flies generally parallel to the surface of the disk. Improperly adjusted static attitude of a suspension can cause the head slider to deviate from this parallel relationship with the disk along the longitudinal x-axis of the suspension and/or the y-axis of the suspension, resulting in errors known as “roll errors” and “pitch errors”, respectively. To minimize or eliminate these pitch and roll errors, static attitude angles of a head suspension are commonly measured and adjusted while the head suspension or head suspension assembly is clamped or fixtured in a loaded state so as to simulate its flying position. In other words, a loaded state is created with the base plate rigidly secured and the load beam urged against its bias force, such as by a pin near its center, to be positioned at its intended fly height. Generally, such loading is performed on the load beam because it is very difficult to directly load a slider mounting tongue or a slider mounted thereto without changing its static attitude angles. However, loading of the load beam itself is also difficult because of the clamping and fixturing that is needed. Such load beam loading can also introduce an angular bias because the loading force is not applied at the slider mounting tongue or slider. Additionally, non-centered loading of the load beam may further introduce an angular bias.

After the suspensions are manufactured and the necessary adjustments thereto are made, such as the types of adjustments discussed above, the sliders are typically bonded to the portion of the suspension known as the gimbal flexures to form head suspension assemblies. Mounting of the slider can take place at any point relative to the process or multiple processes of adjusting the suspension to meet various performance-based requirements, such as gram load, static attitude, and the like. After the sliders are attached to the flexures, the gram loads and other suspension characteristics may again be measured to determine whether the addition of the sliders changed any of the suspensions such that they require further adjustments. Again, separate fixtures or other devices may be provided to support the head suspension assemblies during additional adjustments thereof.

A plurality of these precisely adjusted head suspension assemblies are then typically positioned in a stacked arrangement to form a head stack assembly, with each head suspension assembly also being mounted to an actuator arm that extends from a rotating actuator shaft. Although final adjustments can be made to the suspensions at this point to further insure the accurate positioning of the various aspects of the suspensions, the suspensions are typically spaced so close to each other that it is difficult to access the top, bottom, or other interior component surfaces with measurement equipment. Thus, all or most measurements that can be taken are typically taken from the sides of the head stack assembly. Further, even if certain measurements can be taken, it is often either difficult or impossible to insert any equipment in the small spaces between the disks to perform the necessary adjustments. In some cases, it may thus be necessary to disassemble the head stack assembly to remove and adjust various parameters of the suspensions that do not fall within certain tolerance ranges. After the components of the head stack assembly are satisfactorily adjusted, the assembly can then be positioned relative to a stack of disks in a disk drive so that the suspensions with attached sliders extend into the small spaces between adjacent disks.

To accommodate the increasing consumer demand for smaller electronic devices, it has become more desirable to design and manufacture correspondingly smaller disk drives. Such disk drives will necessarily have even smaller spaces between adjacent disks in a head stack assembly, and will thus require even more accuracy in adjusting the various aspects of the suspensions used in the head stack assemblies so that the read/write heads are precisely positioned relative to the disk surfaces. However, these smaller spaces between the disks also make any adjustments in the suspensions even more difficult to accomplish once the suspensions are part of a head stack assembly. Thus, it is desirable to provide a device and method to accurately measure and adjust the suspensions of a head stack assembly without requiring disassembly and reassembly of the head stack assembly.

### SUMMARY OF THE INVENTION

In one aspect of the invention, a method of measuring and adjusting at least one of a plurality of head suspension assemblies in a head stack assembly is provided, each head suspension assembly having a pivot axis. The method comprises the steps of stacking a plurality of head suspension assemblies in a head stack assembly so that the pivot axis of each head suspension assembly is aligned with the pivot axis of at least one adjacent head suspension assembly, wherein at least one of the head suspension assemblies is rotated about its pivot axis relative to at least one adjacent head suspension assembly so that all of the plurality of head suspension assemblies are not in vertical alignment within the head stack assembly, then measuring at least one parameter of at least one head suspension assembly. The method further comprises the step of then rotating each of the plurality of head suspension assemblies that are not in vertical alignment with the other head suspension assemblies about its pivot axis until the plurality of head suspension assemblies are vertically aligned within the head stack assembly.

The method may further include adjusting at least one measured parameter of the at least one head suspension assembly before rotating the head suspension assemblies to be vertically aligned within the head stack assembly and may further include securing the plurality of head suspension assemblies within the head stack assembly after rotating the head suspension assemblies to be vertically aligned. The method may also comprise the step of reorienting the head stack assembly from a first orientation to a second orientation after the step of measuring at least one parameter of at least one head suspension assembly and may further include the step of measuring at least one parameter of at least one head suspension assembly after the head stack assembly is reoriented to the second orientation. In the method, each of the plurality of head suspension assemblies has a first surface and an opposite second surface, and wherein the stacking step may further comprise stacking the head suspension assemblies with the first surface and second surface of each assembly facing in the same general direction or may comprise stacking the head suspension assemblies so that the first surface of at least one head suspension assembly faces in the same general direction as the second surface of at least one other head suspension assembly within the head stack assembly. The each pivot axis may be positioned within a periphery of its respective head suspension assembly, or may be positioned external to a periphery of its respective head suspension assembly. The method may also comprise the steps of providing a plurality of disks in a stack, measuring at least one parameter of at least one of the disks, correlating the measured disk parameter to at least one measured parameter of the at least one head suspension assembly, then adjusting the at least one measured parameter of the at least one head suspension assembly.

In another aspect of the invention, a head suspension measuring and adjusting system is provided for measuring and adjusting at least one parameter of each of a plurality of head suspension assemblies arranged in a head stack assembly. The system comprises a head stack assembly comprising a plurality of head suspension assemblies, wherein each head suspension assembly comprises a pivot axis that is aligned with the pivot axis of at least one adjacent head suspension assembly, and wherein each of the head suspension assemblies is rotatable about its pivot axis to be misaligned with the other head suspension assemblies within the head stack assembly and further rotatable about its pivot axis to be aligned with at least one of the other head suspension assemblies within the head stack assembly.

### BRIEF DESCRIPTION OF THE DRAWINGS

The present invention will be further explained with reference to the appended Figures, wherein like structure is referred to by like numerals throughout the several views, and wherein:

FIG. 1 is a perspective view of one embodiment of a head suspension assembly to which the present invention is applicable;

FIG. 2 is a top view of a gimbal region of a flexure of the type shown in FIG. 1 that can be used in a head suspension assembly, including a slider mounted to a slider mounting tongue;

FIG. 3 is a side view of one embodiment of a head suspension assembly shown in an unloaded state;

FIG. 4 is a partial side view of a head suspension assembly of the type shown in FIG. 3, with the head suspension assembly shown in combination with a disk of a dynamic storage device and showing in particular the slider of the head suspension assembly flying with respect to the disk in the typical operating position and with the head suspension assembly in a loaded state;

FIG. 5 is a side view of a head suspension assembly of the type illustrated in FIG. 4, with the head suspension assembly shown in a loaded condition and illustrating the pitch static attitude of the slider of the head suspension assembly;

FIG. 6 is a perspective view of a portion of a disk drive, including a stack of disks and a corresponding head stack assembly;

FIG. 7 is a top view of an arrangement of multiple head suspension assemblies connected to actuator arms and rotated about a common axis in accordance with the present invention;

FIG. 8 is a side view of two head suspension assemblies attached to a single actuator arm, each of the head suspension assemblies facing in an opposite direction relative to the faces of adjacent disks; and

FIG. 9 is a side view of an E-block assembly of multiple head suspension assemblies and corresponding actuator arms.

### DETAILED DESCRIPTION OF THE PREFERRED EMBODIMENTS

Dynamic data storage devices that include rigid or floppy disks, such as magnetic or optical storage drives, are well known in the industry. Rigid magnetic drives, for example, use a rigid disk coated with a magnetizable medium for storage of digital information in a plurality of circular, concentric data tracks. The disk is usually mounted on a motorized spindle that spins the disk and causes the top and bottom surfaces of the disk to pass under or over adjacent read/write heads. A typical head includes a hydrodynamic or air bearing slider and a transducer for writing information to and/or reading information from the disk surface. An actuator mechanism moves the heads from track to track across the surfaces of the disk under control of electronic circuitry. The actuator mechanism includes an actuator arm and a head suspension assembly for each head. Head suspension assemblies, also sometimes known as head gimbal assemblies, are commonly used in rigid disk drives to support the heads in close proximity to the rotating disk surfaces. Multiple head suspension assemblies are often precisely adjusted then assembled into a head stack assembly for reading surfaces of multiple disks. Methods and devices for providing precise adjustment of the head suspension assemblies in accordance with the present invention are described below in detail.

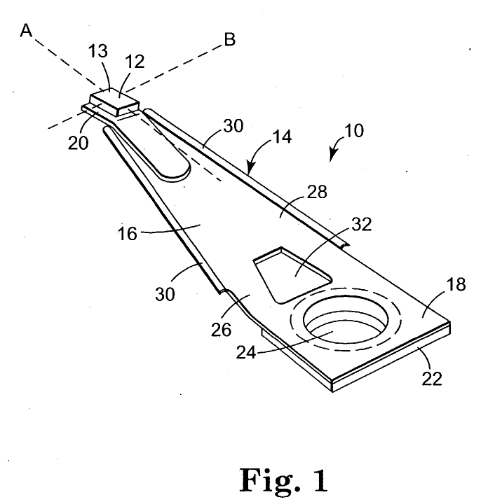

Referring now to the Figures, wherein the components are labeled with like numerals throughout the several Figures, and initially to FIG. 1, one preferred configuration of a head suspension assembly 10 is illustrated. As shown, head suspension assembly 10 includes a head slider 12 mounted to a head suspension 14. The head suspension 14 includes a load beam 16 having a mounting region 18 on its proximal end and a gimbal or flexure 20 on its distal end. When incorporated into a disk drive, the mounting region 18 can be mounted to an actuator or positioning arm (not shown) which supports the head suspension assembly 10 relative to the rotating disk. A baseplate 22 having a mounting hole 24 is typically welded or otherwise attached to the mounting region 18 to increase the rigidity of the mounting region and to provide a mechanism for securely mounting the head suspension assembly 10 to the actuator arm. As shown, the load beam 16 is an elongated and generally triangularly-shaped member which includes a spring section 26 adjacent to the mounting region 18 for creating a preload bias, and a rigid section 28 which extends from the spring section 26. Typically, the rigid section 28 includes stiffening features 30, such as rails, that extend along at least a portion of the sides of the rigid section 28 for transferring the preload bias to the flexure 20 and thus slider 12. The spring section 26 of the head suspension assembly 10 shown in FIG. 1 includes a central opening 32 that forms the spring section 26 into two legs on opposite sides of the opening 32, as shown. In this embodiment, the flexure 20 is manufactured as a separate member, and attached to the distal end of the rigid region 28 by welding or other suitable technique. However, the flexure may instead be formed integrally with the distal end of the rigid region 28 of the load beam 16 using known forming techniques suitable for the material used, such as etching the flexure in the distal end of the load beam 16. The head slider 12 generally includes a read/write head (not shown) mounted to a portion thereof, has an air bearing surface 13, and is typically bonded to the flexure 20 by adhesive or the like.

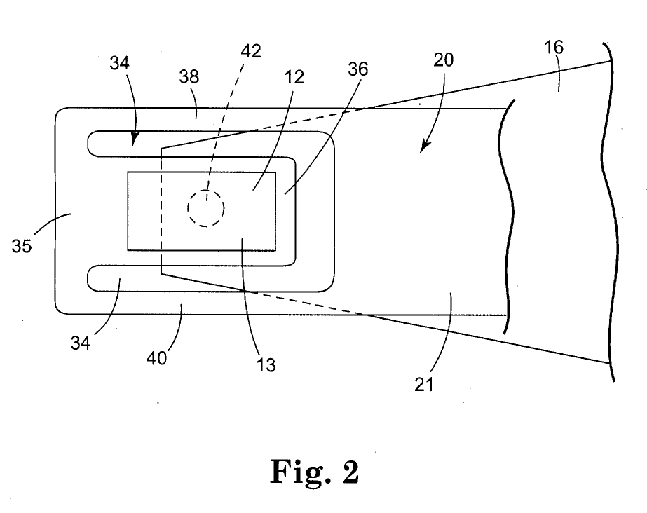

FIG. 2 illustrates a partial top view of the distal end of the head suspension assembly 10 of FIG. 1. As described above, the flexure 20 is attached to the distal end of the load beam 16 by welding or other suitable technique, and in this embodiment is attached to the load beam 16 at a mounting portion 21 of the flexure 20. The other portions of the flexure 20 that are not attached to load beam 16 extend from the mounting portion 21 and can generally flex relative to the load beam 16. The flexure 20 has a cutout 34, which in the illustrated embodiment is generally U-shaped, that forms a slider mounting tongue 36 for mounting the slider 12 thereon. The cutout 34 also forms a first gimbal arm 38 and a second gimbal arm 40 that are each attached to the slider mounting tongue 36 by a crossbar portion 35 and each of which extend distally from the mounting portion 21. The load beam 16 typically also has a load point dimple 42 that can engage with a back surface of the slider mounting tongue 36, the function of which is described below with respect to FIG. 4. Alternatively, such a load point dimple 42 could extend from the slider mounting tongue 36 to engage a distal portion of the load beam 16.

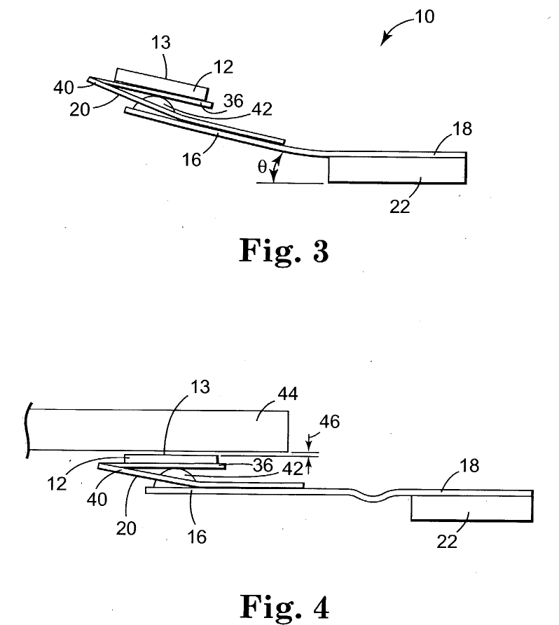

In FIG. 3, the head suspension assembly 10 is schematically shown in an unloaded state. Generally, in the unloaded state, the back surface of the tongue 36 rests against the apex of the spherical load point dimple 42 under the spring action of the gimbal arms 38 and 40, which spring action is caused by their flexing caused by the height of the load point dimple 42. As can be seen in FIG. 3, the rigid section 16 of load beam 16 is at an angle θ relative to the baseplate 22. The bend of the spring region 26 provides a preload bias to urge the slider 12 toward an adjacent disk in operation. In the unloaded state of the head suspension assembly 10, as shown in FIG. 3, no actual preload is present since the head suspension assembly is not flexed or moved in a direction away from its unloaded state

Referring to FIG. 4, the head suspension assembly 10 is shown in use with a rotating hard disk 44. As mentioned above, the head suspension assembly 10 provides a preload bias to urge the slider 12 toward a surface of the disk 44. As the disk 44 rotates, the disk 44 drags air along the air bearing surface 13 in a direction approximately parallel to the tangential velocity of the disk 44. As the air passes between the slider 12 and the disk 44, friction on the aerodynamically designed air-bearing surface 13 causes the air pressure between the disk 44 and the air bearing surface 13 to increase, which creates a hydrodynamic lifting force that causes the slider 12 to fly relative to the surface of the disk 44. The preload bias supplied by the spring region 26 of the load beam 16 counteracts the hydrodynamic lifting force. The preload bias and the hydrodynamic lifting force reach equilibrium based upon the hydrodynamic properties of the slider 12 and its air bearing surface 13 and the speed of rotation of the disk 44. The preload bias is transferred from the load beam 16 to the slider 12 through the load point dimple 42, which provides a point about which the slider 12 can pitch and roll and it limits vertical displacement of the slider 12 and flexure 20 in a direction away from the disk surface. The rotation of the disk 44 causes the slider 12 to be positioned a distance 46 from the surface of the disk 44. The distance 46 is referred to as the slider “flying height” and represents the position that the slider 12 occupies when the disk 44 is rotating during normal operation. If the flying height 46 is not maintained within a certain predetermined range, the quality of the data read from the disk 44 or written on the disk 44 generally degrades. Further, if the flying height 46 is essentially eliminated during operation of the disk drive, the slider 12 may come in contact with the surface of the disk 44, which can cause a catastrophic disk drive failure and may cause permanent damage to the disk drive components.

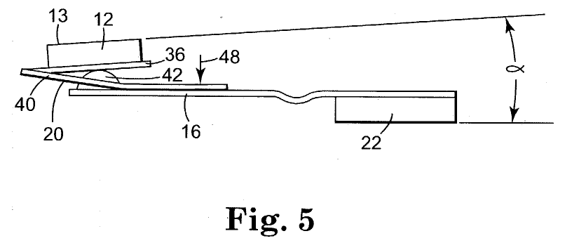

In FIG. 5, the load beam 16 is schematically shown held in a loaded state as loaded by an external means, such as a force indicted generally by arrow 48. This type of configuration may occur in a fixture or other specially designed device in which various aspects of the head suspension assembly 10 can be precisely adjusted before the assembly 10 is used in a disk drive, as discussed below. Here, the angle θ of FIG. 3 is reduced from the unloaded state and the preload bias acts in the direction opposite that of arrow 48. In this configuration, the air bearing surface 13 and the bottom surface of the baseplate 22 define an angle α. It is understood that the angle α may also be referenced from a surface of the flexure 20 such as a surface of the slider mounting tongue 36 or from any other datum chosen along the head suspension. The angle α is referred to as the pitch static attitude and generally defines a pitch aspect of the planar orientation of a surface of the slider 12 as taken about the pitch axis B shown in FIG. 1. In addition, an angle referred to as the roll static attitude generally defines a roll aspect of the planar orientation of a surface as taken about the roll axis A shown in FIG. 1.

As previously discussed, due to the extremely small spaces between the components of a head stack assembly, it can be difficult or impossible to measure and adjust the various components of a head stack assembly after the stack is assembled and secured. The present invention provides a process for making accurate measurements and adjustments of various aspects of head stack assembly components, where the measurement and adjustment can occur immediately before the final assembly and securing of the assembly takes place. This proximity of the final measurements and adjustments to the final assembly of the head stack assembly provides an additional opportunity to eliminate any misalignments that may have occurred in the various steps of handling the head suspension assemblies. Many adjustments can be made with the methods of the present invention, such as adjustments to the static attitude of a head suspension or head suspension assembly, including the pitch static attitude and the roll static attitude. Other adjustments that may be made in accordance with the present invention include gram load adjustments, load beam geometry adjustments, and the like. Although these measurements are typically determined when a head suspension or head suspension assembly is being held in a specifically designed fixture, various parameters may instead be measured and adjusted in accordance with the present invention when multiple head suspension assemblies are stacked or arranged in the same general vertical positions as they will have in a head stack assembly, but are rotated or splayed relative to each other.

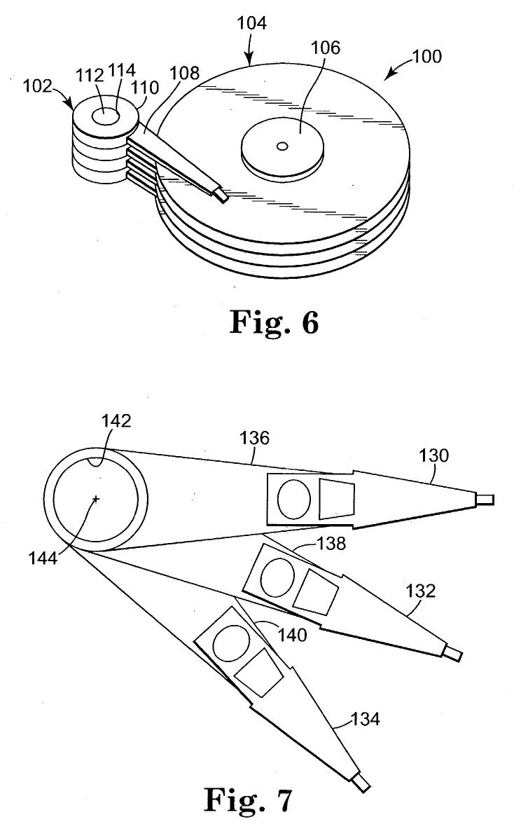

To better describe the features of the present invention, FIG. 6 shows a head stack assembly in its final, assembled form as it would typically be used in a disk drive. In particular, FIG. 6 illustrates one embodiment of a portion of a disk drive assembly 100, which includes a head stack assembly 102 positioned adjacent to a corresponding stack of disks 104 that are arranged to be generally parallel to each other and to rotate about a common spindle 106. The head stack assembly 102 includes a plurality of head suspension assemblies 108 having actuator arms 110 that are vertically stacked about a common bearing 112 in such a way that the bearing 112 extends through an opening 114 of each actuator arm 110. These actuator arms 110 with their corresponding head suspension assemblies 108 are retained by the bearing 112 by the application of a compressive force parallel to the longitudinal axis of the head stack assembly 102. Alternative ways of retaining the head suspension assemblies 108 in this vertically stacked orientation including using bolts, threaded cylindrical fasteners, or swaged or interference fit connectors of the types described above. In any case, the entire head stack assembly 102 can rotate about bearing 112 to controllably position the read/write heads of the head suspension assemblies 108 so that all of the heads are adjacent to certain tracks on the disk surfaces.

Actuator arms, such as actuator arms 110 of FIG. 6, can have a wide variety of sizes and shapes, as desired and necessary for the particular devices in which they will be used. In many cases, the actuator arm is attached generally at its distal end to a mounting area of one or more head suspension assemblies by any known attachment method. The actuator arms typically also include a coil portion at their proximal ends so that the coil portion is at the generally opposite end of the assembly from the end that includes the slider and read/write head. The coil portion is preferably designed to interact with a pair of permanent magnets that form a voice coil motor for rotating the entire actuator assembly about a pivot axis. In this way, the voice coil motor can controllably position the read/write heads relative to adjacent disk surfaces. More particularly, the voice motor coil can rapidly pivot an actuator arm and connected head suspension assemblies about a pivot axis to controllably position the read/write head adjacent to certain tracks on the disk surfaces in response to some type of control signal. Many electronic devices utilize technology and processes that similarly provide control of read/write head positions through a connected actuator arm.

In accordance with the present invention, before multiple head suspension assemblies and the actuator arms to which they are connected are secured in a stacked configuration, such as described above relative to FIG. 6, they are arranged in a splayed or fanned configuration, as illustrated in FIG. 7. This figure illustrates three head suspension assemblies 130, 132, and 134 that are connected to actuator arms 136, 138, and 140, respectively. Each of the actuator arms has an opening 142 generally at its distal end, where the openings are aligned with one another about a common bearing or other apparatus (not shown) that extends through these openings. The apparatus that is inserted into these openings may be removable, if desired. As shown, because the actuator arms and head suspension assemblies are rotated relative to one another, the top, bottom, and side surfaces are much more easily accessible for measurement and adjustment purposes. In this embodiment, the actuator arms 136, 138, and 140 are preferably arranged in the same vertical configuration relative to each other as they will be provided in the final head stack assembly. That is, each actuator arm and its corresponding head suspension assembly will be situated in the same vertical relationship relative to the other actuator arms and their corresponding head suspension assemblies as will occur in the disk drive. Therefore, it is preferable that the components of the head suspension assemblies and actuator arms are generally in the same horizontal plane as they will be when the head stack assembly is completed.

As generally described above, the head suspension assemblies 130, 132, and 134 and actuator arms 136, 138, and 140 are rotated about a pivot axis 144 that extends generally through the center of the opening 142. To keep the assemblies aligned in generally the same arrangement in which they will be arranged in the disk drive, some type of apparatus, such as a cylindrical rod, may be inserted through the opening 142. This apparatus may be a component that becomes part of the final assembly, where final measurements and adjustments are made to the head suspension assemblies 130, 132, and 134 when they are oriented in their splayed position about the apparatus, then the head suspensions and their respective actuator arms are rotated to their operating position (e.g., vertically aligned in a stack) about the same apparatus. A final clamping or locking of the components will preferably be made prior to putting the head stack assembly into operation. Alternatively, this apparatus may be a temporary device that is used only until the measurements and adjustments of the components are completed, then is removed so that a permanent bearing or other device can be inserted through the opening 142, as will be used in operation of the disk drive.

In any of the embodiments of the present invention, it is contemplated that there are preferably at least two orientations about a common pivot axis in which the head suspension assemblies and actuator arms can be secured relative to each other in each head stack assembly. In particular, it is preferable that the head suspension assemblies and actuator arms at least can be positioned in a first or temporary position in which the components are rotated or splayed relative to each other so that measurements and adjustments of the components can be made, and a second or final position in which the components are vertically aligned with each other in the manner in which they will be arranged in operation in an electronic device. When the components, such as head suspension assemblies, are described as being vertically aligned herein, the components are preferably within a predetermined specification range for alignment of stacked components when viewed from above the stack. In many cases, plural identical head suspension assemblies are arranged in a stack with very tight tolerances that require essentially exact vertical alignment of multiple components. It is understood, however, that the term “vertical” does not necessarily require that the axes of the components are perpendicular to a horizontal plane, but is instead intended to describe the preferred orientation of the head stack assembly when it is used in an electronic component. If the entire head stack assembly is instead tilted or otherwise oriented relative to a horizontal plane, the vertical alignment would preferably be determined from a position generally above the stack, and more preferably be determined as viewed perpendicular to a top or bottom face of a head suspension assembly.

In accordance with the present invention, the components can be arranged in a wide variety of positions about an axis, depending on the requirements of that particular head stack assembly. For example, it may be possible that each of the actuator arms is rotatable 360 degrees about a pivot axis to provide maximum flexibility in the arrangement of the actuator arms about the axis. It is also possible that the actuator arms are limited to a certain range of motion, or that the actuator arms can be rotated only to a certain number of predetermined positions about a pivot axis. In any case, it is desirable that the actuator arms can be rotated enough relative to their vertically aligned position to allow access to the portions of the head suspension assemblies for the desired measurement and adjustment thereof. Thus, if it is desirable that the entire top and bottom surfaces of the head suspension assemblies are visible and/or accessible, these head suspensions should preferably have a range of rotation that is at least large enough to provide such access. On the other hand, such a large range of motion may not be necessary if only the slider portions or distal ends of the head suspension assemblies need to be accessible, since even a small amount of rotation will move these ends so they are not obstructed by other head stack assembly components.

Although a large range of rotation about a pivot axis may be made available for the head suspension assemblies, it is possible that there may still be significant overlap of the components such that all surfaces of these components are not accessible or visible when viewed in certain directions. In fact, it may be desirable to use measurement and adjustment techniques that require the components to overlap each other in such a way that access is provided through holes in each of the head suspension assemblies (e.g., central opening 32 of the head suspension assembly 10 of FIG. 1) to adjacent head suspension assemblies. In this type of an arrangement, various techniques may be used to modify parameters of the head suspension assemblies, such as using light beams that can be directed through an opening in one head suspension to an adjacent head suspension, which can either provide a particular measurement of that suspension, and/or may be used to actually modify a suspension that requires adjustment, such as can be done with light that heats the suspension to modify its parameters in some way.

One such example of a method of using light to measure the angles of various component surfaces, such as may be done through an opening in a head suspension assembly or on any visible or accessible head suspension assembly surface, includes using an optical method known as autocollimation. An autocollimator is able to measure small surface angles with very high sensitivity. Light is passed through a lens where it is collimated prior to exiting the instrument. The collimated light is then directed toward a surface, the angle of which is to be determined. After being reflected by the surface to be measured, light enters the autocollimator and is focused by the lens. Angular deviation of the surface from normal to the collimated light will cause the returned light to be laterally displaced with respect to a measurement device such as an eyepiece or a position sensing device. This lateral displacement is generally proportional to the angle of the surface and the focal length of the lens. With autocollimators, it is also possible to direct white light through an opening as small as a pinhole to create a point source at a distance from the lens equal to the focal length of the lens. Thus, head suspension assembly components may be provided with a very small opening of this type that can be used for measuring aspects of adjacent head suspension assemblies that are not otherwise visible or accessible, then adjustments of more accessible aspects of those head suspension assemblies may be made, if necessary. Laser light sources may also be utilized for an autocollimator, where the high intensity of the laser beam creates ultra-low noise measurements, increasing the accuracy and repeatability of the measurements. The high laser intensity also increases the working distance and permits angle measurement from non-mirror-like surfaces, which provides additional flexibility in the arrangement of head suspension assemblies.

In accordance with the present invention, a variety of measurements and adjustments to various parameters of the head suspension assemblies and actuator arms may be made when the components are in their rotated or splayed orientation, as will be described in further detail below. During this time, a temporary clamping or holding means may be used to keep the components properly positioned and secured in their splayed orientation for the desired measurements and adjustments. After the components are adequately adjusted, they may then be loosened from their temporary holding mechanism and rotated about a common axis to their vertically aligned position. At this point, additional measurements of the components may be taken, if desired. If further adjustments are determined to be necessary, the components can be moved back to their splayed positions for those adjustments. This sequence of measurements, adjustments, and component rotations can be repeated any number of times until the components are precisely configured as desired for use in a disk drive. At this point, the components may be permanently secured in their final position with any desired clamping devices or methods.

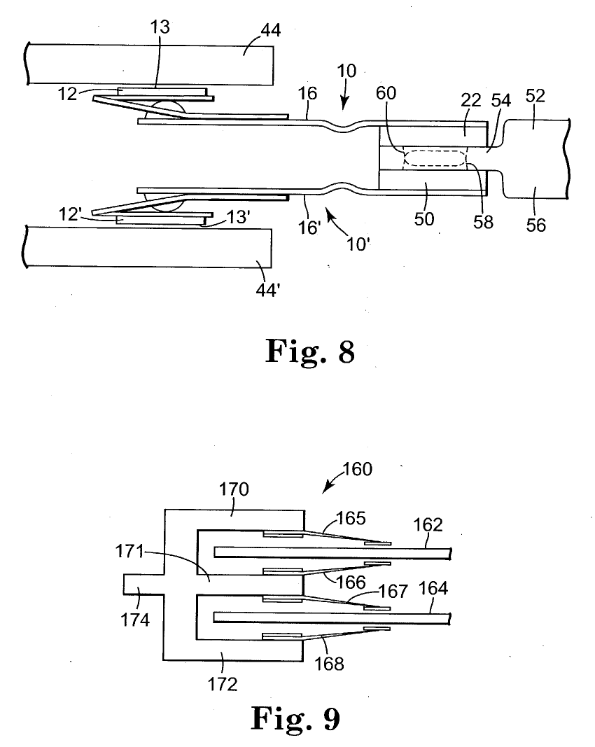

FIG. 8 illustrates another embodiment of a method of securing head suspension assemblies in a disk drive, where two head suspension assemblies of the type shown in FIGS. 1-5 are used in this assembly as an exemplary type of head suspension assembly in accordance with the methods and devices of the present invention. It is noted that the devices and methods of securing this type of head stack assembly may also be used in other head stack assembly configurations, such as that shown and described relative to FIG. 7. Specifically, FIG. 8 shows a side view of two head suspension assemblies 10 and 10′ is shown, with the assemblies arranged in an opposite orientation from each other so that their respective head sliders 12 and 12′ are facing in opposite directions. Slider 12 is positioned with its air bearing surface 13 adjacent a disk 44, and slider 12′ is positioned with its air bearing surface 13′ adjacent a disk 44′. As shown, the head suspension assembly 10 includes a baseplate 22 adjacent one end of its load beam 16, while the head suspension assembly 10′ includes a baseplate 50 adjacent one end of its load beam 16′, with both baseplates 22 and 50 connected to a rigid actuator arm 52. This embodiment of actuator arm 52 is provided with a thinner portion 54 to which the baseplates 22, 50 attach, and a thicker portion 56 that provides the necessary rigidity to the arm 52. This thinner portion 54 of actuator arm 52 is provided to minimize the thickness of the assembly, as disclosed in U.S. Pat. No. 5,963,383, the entire disclosure of which is incorporated herein by reference. The actuator arm 52 may instead have a number of different configurations, however, including an arm 52 that does not vary in thickness along its length.

The baseplates 22 and 50 are provided with an opening or hole (such as opening 24 of baseplate 22 shown in FIG. 1) and an extending boss portion 58 and 60 that generally surrounds the openings of baseplates 22 and 50, respectively. In this embodiment, the boss portion 58 of baseplate 50 is sized to accept the boss portion 60 of baseplate 22 to connect these two plates to each other and also to interconnect these baseplates 22 and 50 with the actuator arm 52. In other words, the boss portions 58 and 60 at least partially overlap each other, where the amount of overlap between these portions depends on their specific configurations. As discussed above, the baseplates 22 and 50 can be welded or otherwise attached to the mounting region of their respective load beams 16 and 16′ to increase the rigidity of the mounting region, however, these baseplates 22 and 50 may not be physically connected to an adjacent load beam before they are connected to each other through a hole or opening in the actuator arm 52.

When baseplates include extending boss portions of the type described above, the boss portions may be designed to provide a press or interference fit that is sufficient to secure the two boss portions to each other when they are pressed together. This type of connection typically requires more precise machining than when some other connection methods are used. Alternatively, swaging the baseplates to each other in accordance with processes known in the art can complete the baseplate connection. Swaging typically involves physically forcing a swaging ball or swaging tool through a swaging opening, which causes the outer surfaces of the swaging opening to deform slightly, thereby causing an interference fit between the deformed surface and an adjacent surface which it contacts. With specific reference to FIG. 8, for example, a swaging tool can be inserted into the opening in the boss portion 60 of baseplate 22, which provides an outward force that causes the boss portion 60 to deform slightly outward to form a tight interference fit between the boss portion 60 and the boss portion 58 of the baseplate 50. Preferably, the swaging tool is large enough in circumference that it provides an outward force that sufficiently large to also cause the boss portion 58 of the baseplate 50 to deform slightly outward to form a tight interference fit between the boss portion 58 and the corresponding hole in the actuator arm 52. In addition, the size of the swaging tool and the corresponding outward forces that the tool generates preferably result in a deformation of the opening in the actuator arm 52 that is an elastic deformation. In this way, the boss portions and their respective head suspension assemblies can be disassembled without causing permanent damage to the actuator arm. Although the deformation of the boss portions 58 and 60 can often be a permanent or plastic deformation due to the type and thicknesses of materials from which they are typically made, the materials could also be chosen to allow for elastic deformation of the boss portions. It is further contemplated that while the openings in the actuator arm 13 and the corresponding boss portions 58 and 60 are preferably cylindrical, the openings may be otherwise shaped, as desired.

When components will be swaged for securing in a final, vertically aligned arrangement, as described above, it is contemplated that the components are lightly or temporarily swaged when the components are in a splayed orientation in such a way that only slight permanent or plastic deformation of the connection pieces (e.g., boss portions) occurs. One example of how this temporary swaging may occur is with a swaging tool that is small enough to cause only slight deformation of the components. After the components are precisely measured and adjusted, they can be rotated to their final, vertically aligned positions, and then swaged with the final swaging tool (which is preferably larger than the temporary swaging tool) that causes the desired level of component deformation for the head stack assembly as it will be used in a disk drive. It is contemplated, however, that the components also be lightly swaged initially during further measurements when the components are arranged in their vertically aligned orientation, in order to allow for relatively easy rotation back to the splayed position if further adjustments are necessary. As with the other methods, this sequence of component movement between a splayed orientation and a vertically aligned orientation may be repeated as many times as necessary until the various parameters are properly adjusted for the final head stack assembly. Alternatively, when the components are in their splayed arrangement, a clamping or other holding device or technique may be used so that no deformation of the components occurs until they are swaged in their vertically aligned orientation.

In some cases, it is desirable to rotate each of the components of a head stack assembly so that the components of adjacent assemblies are rotated the same amount relative to each other, as shown in FIG. 7, for example. In this way, the various surfaces of each of the head suspension assemblies will be equally accessible for measurements and adjustments. It is also contemplated, however, that some of the components may be rotated in such a way that some of the head suspension assemblies will be more visible and accessible than others in the same head stack. This may be desirable, for example, if one or more of the head suspension assemblies need adjustments in areas not requiring adjustment on other head suspension assemblies. In fact, it may be desirable for all of the head suspension assemblies to be vertically aligned except for one such assembly that can be rotated, measured, and adjusted as necessary before rotating it back into vertical alignment with the rest of the stack of head suspension assemblies.

A configuration such as that shown in FIG. 8 is one example of a device including two head suspension assemblies connected to a single actuator arm, where the sliders of the head suspension assemblies are facing in opposite directions to read two different disk surfaces. Alternatively, multiple head suspension assemblies facing in the same direction may be connected to a single actuator arm, or each actuator arm may have only a single attached head suspension assembly. Typically, however, there is at least one head suspension assembly for each actuator arm. Many other combinations of actuator arms and head suspension assemblies may also be used in a wide variety of electronic devices. Some electronic devices will also require the inclusion of additional read/write heads for processing information, which would typically also include additional corresponding head suspension assemblies.

When an electronic device includes multiple actuator arms with corresponding attached head suspension assemblies, they may also be arranged relative to each other in a configuration referred to as an E-block assembly. FIG. 9 illustrates one example of an E-block assembly 160, which shows a portion of two magnetic disks 162 and 164 that are arranged to be generally parallel to each other and to rotate about a common spindle (not shown). Multiple head suspension assemblies 165, 166, 167, and 168 are coupled or attached to three actuator arms 170, 171, and 172 in a structure that resembles the letter ‘E’, thereby forming a head stack assembly. The actuation arms 170, 171, and 172 are coupled to a voice coil 174 which can interact with a positioning system (not shown) to rotate the entire E-block assembly or head stack assembly 160 relative to the disks 162 and 164. During operation, the head stack assembly 160 simultaneously moves all of the head suspension assemblies 165-168 in a radial direction relative to the surfaces of the disks 162 and 164 so that the suspensions extend into and out of the spaces between adjacent disks, as desired.

When head stack assembly components are part of an E-block assembly, the same issues described above relative to tight spacing and close tolerances between adjacent, vertically aligned components can also make the measurement and adjustment of components difficult or impossible in an E-block arrangement. Thus, in accordance with the present invention, it is advantageous to splay the components of an E-block assembly about a rotation axis so that the various surfaces of the assemblies are visible and/or accessible for measurement and rotation thereof, similar to the arrangement shown in FIG. 7. As with any of the techniques described above or other appropriate securing methods, the head suspension assembly and other components may be temporarily held in their splayed position until the desired measurements and adjustments are complete, at which time the components may be rotated to their vertically aligned arrangement. If desired, further measurements may again be taken of various parameters of the head suspension assembly and if further adjustments are found to be necessary, the components can again be rotated back to a splayed orientation, measured, readjusted, and rotated back to a vertically aligned arrangement.

In any of the above methods, when the components are in their splayed position (i.e., rotated from a vertically aligned arrangement), various measurements and adjustments may be made, as discussed generally above. Any known or developed measurement and adjustment methods and devices may be used, with the components preferably being held in a loaded state (as illustrated in FIG. 5, for example) for such procedures. However, it is contemplated that the measurement and adjustment procedures can occur with the head suspension assemblies in an unloaded state (as illustrated in FIG. 3, for example), where correlations between the loaded and unloaded states of the components may be empirically determined, if necessary, to arrive at accurate adjustments of the head suspension assemblies as they will be arranged in operation of the disk drive. The particular devices and techniques used for adjusting each particular parameter of a head suspension assembly when splayed in a head stack assembly may be the same or different from the devices or techniques used to adjust that parameter of a head suspension assembly when it is in a separate holding fixture.

A wide variety of measurement and adjustment techniques and devices may be used for different components in accordance with the present invention, where a combination of devices or tools can simultaneously measure and/or adjust various aspects of a head suspension assembly. Multiple tools may approach the components from the same side of the component they will be measuring or from different sides or edges of the component. For example, an elevator or loading tool that is used to load components (i.e., apply force to components) for measurement may approach a head suspension assembly from the same side as the tool that will actually perform the measurement, or may approach it from a different side, surface, or edge. It is also contemplated that measurement stations can be combined so that more than one parameter of each head suspension assembly can be measured simultaneously. For example, the gram load can be measured from one side of a component while the beam profile is being measured from another side of the component. Any combination of simultaneous or sequential loading, measuring, and adjusting of components may be used in accordance with the present invention, where these processes may be performed from any side or surface of the component that is appropriately visible and/or accessible to perform the necessary techniques.

With any of the measurement and adjustment processes used for head suspension assemblies in a splayed configuration, the same or similar tools and techniques may be utilized as when the head suspension assemblies are adjusted in a separate fixture. Alternatively, different tools and techniques may be designed that can simultaneously measure and/or adjust multiple head suspension assemblies. For example, a single fixture may be provided for simultaneously bending the spring region of multiple head suspension assemblies, such as with mechanical bending equipment or with the application of heat, to increase or decrease the gram load in each component, where the amount of bend required can be empirically determined to change the gram load of the suspension to be within a predetermined range. For another example, a single fixture may be provided to simultaneously measure and adjust the static attitude angles of all of the head suspension assemblies to minimize or eliminate pitch and roll errors. Preferably, the head suspension assembly will be in a loaded state during such measurements and adjustments, to simulate the flying position of the components. When loading of components is desired, the head suspension assemblies are preferably splayed sufficiently relative to adjacent components so that the portion of the head suspension assembly that will be contacted by a loading pin or device is easily accessible. As discussed herein, when it is desirable for certain portions of components to be accessible for measurement and adjustment purposes, there may be a need for one or both opposite faces of the component to be accessible, depending on the particular parameter that needs measurement and adjustment. It is understood that while simultaneous measurement and adjustment of various parameters of head suspension assemblies in a splayed arrangement may be advantageous to minimize the time required to adjust multiple components, the various parameters may instead be measured and adjusted sequentially when in a splayed arrangement.

In any case, the tools' may be designed so that they can measure components that are facing in either direction, or the tools may be fixed so that they can only measure components facing in one direction (e.g., components facing up or components facing down). With the latter type of tools, it may be necessary to measure and/or adjust one side of the components, then turn the stack of head suspension assemblies over or otherwise reorient these components to measure and/or adjust another side or aspect thereof. This reorientation of head suspension assemblies may be performed as many times as necessary, along with as many rotations of components from their splayed to their vertically aligned orientation as necessary to achieve the desired component alignment. One exemplary method would comprise the steps of assembling a stack of head suspension assemblies splayed about a pivot axis, with some of these assemblies facing up and some facing down, such as is shown in FIG. 8, for example. All of the desired measurements and adjustments of the components facing in one direction can be performed, and then the stack can be turned over to measure and adjust the desired parameters of the components facing in the other direction. This sequence of turning the stack over can be repeated as many times as necessary, along with multiple rotation of components about the pivot axis, until the components are properly adjusted. After the adjustments are complete, the components may then be secured permanently or semi-permanently in a head stack assembly.

When using the techniques described above, or any other applicable techniques or devices for measurement and adjustment of components of a head stack assembly, it may be possible that precise adjustment of splayed components correlates exactly to the orientation of these components when they are vertically aligned. That is, it may be possible that a head suspension assembly that appears to be precisely adjusted relative to a particular parameter when in a splayed orientation may not be precisely adjusted when it is rotated to its vertically aligned or final position. This may occur, for example, due to slight differences in the way the components are oriented in their splayed and vertically aligned positions. In these situations, certain correlation information should be gathered so that the components will be precisely adjusted when in their vertically aligned position. For example, it may be necessary to purposely adjust a certain parameter of a splayed head suspension assembly so that it is seems to be at least slightly misadjusted or misaligned, with an understanding of how this misadjustment will be “corrected” or changed when the component is moved to its vertically aligned position, as described generally below.

In one aspect of the present invention, empirically determined information as obtained by experimentally rotating similar head suspension assemblies while in a splayed orientation of a head stack assembly can be utilized as part of this process, in particular, for correlating head suspension assembly characteristics in a splayed orientation with head suspension characteristics in a final, vertically aligned arrangement. For example, with respect to one preferred static attitude adjustment method, the static attitude of a slider mounting tongue or a slider may be determined in its splayed position within a head stack assembly and the planar orientation of a reference surface such as a surface of a load beam may also be determined for a head suspension assembly in its splayed position. From this information, the static attitude of a slider mounting tongue or slider in its final, vertically aligned position can be determined based upon the correlation with the empirically determined head suspension data. Thus, by the combination of the static attitude and reference planar orientations of a final, vertically aligned head suspension, the splayed static attitude can be reliably predicted from the compilation information obtained from similar splayed head suspension assemblies. The static attitude of a slider mounting tongue or a slider and the planar orientation of a reference surface may then preferably be used to determine an adjustment parameter, such as a direction and magnitude, for bending a gimbal arm of a head suspension or a head suspension assembly and thereby controllably adjusting the static attitude. As such, the static attitude of a slider mounting tongue or a slider to be adjusted may be determined and the above-described adjustment may be performed and the static attitude remeasured until a desired static attitude is achieved.

In another aspect of the invention, a head stack assembly may be positioned adjacent to a stack of disks, where measurements of the surfaces of the disks are used to adjust certain parameters of the head stack assembly components. For one example, a stack of disks may be mounted in its final location (e.g., within a disk drive) and then various measurements of the disk surfaces may be taken. Using empirically determined information correlating the disk surface measurements with characteristics of head suspension assemblies in their splayed arrangement, the splayed head suspension assemblies may then be measured and adjusted accordingly and secured in a head stack assembly. This technique will allow the head stack assembly to then be precisely mounted relative to the disks in the disk stack. Alternatively, a stack of disks and a splayed head stack assembly may be mounted in their final locations within a disk drive where various measurements of the components may be taken. Again, using empirically determined information, various adjustments of the head suspension assemblies may be performed that provide precise alignment of the head stack assembly components both within the head stack assembly itself and relative to a particular stack of disks within a disk drive.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

1. A method of measuring and adjusting at least one of a plurality of head suspension assemblies in a head stack assembly, each head suspension assembly having a pivot axis, the method comprising the steps of:
stacking a plurality of head suspension assemblies in a head stack assembly so that the pivot axis of each head suspension assembly is aligned with the pivot axis of at least one adjacent head suspension assembly, wherein at least one of the head suspension assemblies is rotated about its pivot axis relative to at least one adjacent head suspension assembly so that all of the plurality of head suspension assemblies are not in vertical alignment within the head stack assembly;
measuring at least one parameter of at least one head suspension assembly;
rotating each of the plurality of head suspension assemblies that is not in vertical alignment with the other head suspension assemblies about its pivot axis until the plurality of head suspension assemblies are vertically aligned within the head stack assembly.

2. The method of claim 1, further comprising the step of adjusting at least one measured parameter of the at least one head suspension assembly before rotating the head suspension assemblies to be vertically aligned within the head stack assembly.

3. The method of claim 1, further comprising the step of securing the plurality of head suspension assemblies within the head stack assembly after rotating the head suspension assemblies to be vertically aligned.

4. The method of claim 1, further comprising the step of measuring at least one parameter of at least one of the head suspension assemblies after the head suspension assemblies are vertically aligned within the head stack assembly.

5. The method of claim 1, further comprising the step of securing each of the head suspension assemblies relative to each adjacent head suspension assembly that is vertically aligned within the head stack assembly after the step of rotating the head suspension assemblies.

6. The method of claim 1, wherein each of the plurality of head suspension assemblies is connected to an actuator arm, and wherein each of the actuator arms is rotatable with its attached head suspension assembly about the pivot axis of the head suspension assembly.

7. The method of claim 6, further comprising the step of securing the actuator arms together in a head stack assembly after the step of rotating the head suspension assemblies.

8. The method of claim 1, wherein the step of stacking the head suspension assemblies provides a first orientation for the head stack assembly, the method further comprising the step of reorienting the head stack assembly to a second orientation after the step of measuring at least one parameter of at least one head suspension assembly.

9. The method of claim 8, further comprising the step of measuring at least one parameter of at least one head suspension assembly after the head stack assembly is reoriented to the second orientation.

10. The method of claim 9, further comprising the step of reorienting the head stack assembly from the second orientation to the first orientation after the at least one parameter has been measured.

11. The method of claim 9, further comprising the additional steps of further reorienting the head stack assembly between the first and second orientations and measuring at least one parameter of at least one head suspension assembly after each reorientation of the stack.

12. The method of claim 8, wherein the step of reorienting the head stack assembly comprises rotating the head stack assembly approximately 180 degrees from the first orientation to the second orientation about a secondary axis that is generally perpendicular to the pivot axes of the plurality of head suspension assemblies.

13. The method of claim 9, further comprising reorienting the head stack assembly to a third orientation after measurement of at least one parameter of at least one head suspension assembly with the head stack assembly in the second orientation.

14. The method of claim 1, wherein the step of stacking head suspension assemblies further comprises positioning each of the head suspension assemblies about the pivot axis so that at least a portion of each head suspension assembly is accessible to measurement and adjustment equipment.

15. The method of claim 1, wherein each of the plurality of head suspension assemblies has a first surface and an opposite second surface, and wherein the stacking step further comprises stacking the head suspension assemblies with the first surface and second surface of each assembly facing in the same general direction.

16. The method of claim 1, wherein each of the plurality of head suspension assemblies has a first surface and an opposite second surface, and wherein the stacking step further comprises stacking the head suspension assemblies so that the first surface of at least one head suspension assembly faces in the same general direction as the second surface of at least one other head suspension assembly within the head stack assembly.

17. The method of claim 1, wherein each pivot axis is positioned within a periphery of its respective head suspension assembly.

18. The method of claim 1, wherein each pivot axis is positioned external to a periphery of its respective head suspension assembly.

19. The method of claim 18, wherein each of the plurality of head suspension assemblies is connected to an actuator arm, and wherein each pivot axis is positioned within a periphery of its respective actuator arm.

20. The method of claim 1, further comprising the steps of providing a plurality of disks in a stack, measuring at least one parameter of at least one of the disks, correlating the measured disk parameter to at least one measured parameter of the at least one head suspension assembly, then adjusting the at least one measured parameter of the at least one head suspension assembly.

21. A head suspension measuring and adjusting system for measuring and adjusting at least one parameter of each of a plurality of head suspension assemblies arranged in a head stack assembly, the system comprising a head stack assembly comprising a plurality of head suspension assemblies, wherein each head suspension assembly comprises a pivot axis that is aligned with the pivot axis of at least one adjacent head suspension assembly, and wherein each of the head suspension assemblies is rotatable about its pivot axis to be misaligned with the other head suspension assemblies within the head stack assembly and further rotatable about its pivot axis to be aligned with at least one of the other head suspension assemblies within the head stack assembly.

22. The suspension measuring and adjusting system of claim 21, further comprising at least one measurement device for measuring at least one parameter of each head suspension assembly that is rotated to be misaligned with the other head suspension assemblies.

23. The suspension measuring and adjusting system of claim 22, wherein the measurement device can simultaneously measure at least one parameter of multiple head suspension assemblies.

24. The suspension measuring and adjusting system of claim 21, further comprising. at least one adjustment device for adjusting at least one parameter of each head suspension assembly that is rotated to be misaligned with the other head suspension assemblies.

25. The suspension measuring and adjusting system of claim 24, wherein the adjustment device can simultaneously adjust at least one parameter of multiple head suspension assemblies.

26. The suspension measuring and adjusting system of claim 21, wherein the head stack assembly is rotatable about a secondary axis that is generally perpendicular to the pivot axes of the plurality of head suspension assemblies.
